(19) United States
(12) Patent Application Publication
(10) Pub. No.: US 2012/0084827 A1
(43) Pub. Date: Apr. 5, 2012

(54) Image Display Apparatus and Sound Output Control Method

(76) Inventors: Fujihito Numano, Tokyo (JP); Hiroaki Unno, Kunitachi-shi (JP)

(21) Appl. No.: 13/159,721

(22) Filed: Jun. 14, 2011

(30) Foreign Application Priority Data
Sep. 30, 2010 (JP) 2010-222894

(51) Int. Cl. H04N 7/173

(52) U.S. Cl. 725/110

(57) ABSTRACT

According to one embodiment, an image display apparatus including, a communication processing module configured to receive sound and an image over a network, an image processing module configured to output an image signal, a sound processing module configured to output a sound signal, a converting module configured to convert the sound signal output by the sound processing module to an analog signal, and an adjusting module configured to adjust a time difference to be provided to the sound signal input to the converting module by the sound processing module in accordance with the image signal when the image signal output by the image processing module is an image signal input via the communication processing module.

### CROSS-REFERENCE TO RELATED APPLICATIONS

This application is based upon and claims the benefit of priority from Japanese Patent Application No. 2010-222894, filed Sep. 30, 2010; the entire contents of which are incorporated herein by reference.

### FIELD

Embodiments described herein relates generally to an image display apparatus capable of outputting sound, and a sound output control method for a communication device included in the image display apparatus.

### BACKGROUND

Digital television broadcasting and television receivers (TV apparatuses) capable of receiving the same are becoming remarkably widespread.

The spread of the Internet has enabled programs, that is, content to also be acquired (received) by the TV apparatuses via the Internet.

The Internet also enables the use of voice communication that uses Internet Protocol (IP), that is, IP telephones. The IP telephones enable the sending/receiving of not only sound but also images, in particular, moving images.

### BRIEF DESCRIPTION OF THE DRAWINGS

A general architecture that implements the various features of the embodiments will now be described with reference to the drawings. The drawings and the associated descriptions are provided to illustrate embodiments of the invention and not to limit the scope of the invention.

FIG. 1 is an exemplary diagram showing an example of a television apparatus according to an embodiment;

FIG. 2 is an exemplary diagram showing an example of a routine according to an embodiment;

FIG. 3 is an exemplary diagram showing an example of a routine according to an embodiment;

FIG. 4 is an exemplary diagram showing an example of a display according to an embodiment embodiment;

FIG. 5 is an exemplary diagrams each showing an example of a display according to an embodiment; and

FIG. 6 is an exemplary diagram showing an example of a display according to an embodiment.

### DETAILED DESCRIPTION

Various embodiments will be described hereinafter with reference to the accompanying drawings. In general, according to one embodiment, an image display apparatus comprising: a communication processing module configured to receive sound and an image over a network; an image processing module configured to output an image signal; a sound processing module configured to output a sound signal; a converting module configured to convert the sound signal output by the sound processing module to an analog signal; and an adjusting module configured to adjust a time difference to be provided to the sound signal input to the converting module by the sound processing module in accordance with the image signal when the image signal output by the image processing module is an image signal input via the communication processing module.

Embodiments will now be described hereinafter in detail with reference to the accompanying drawings.

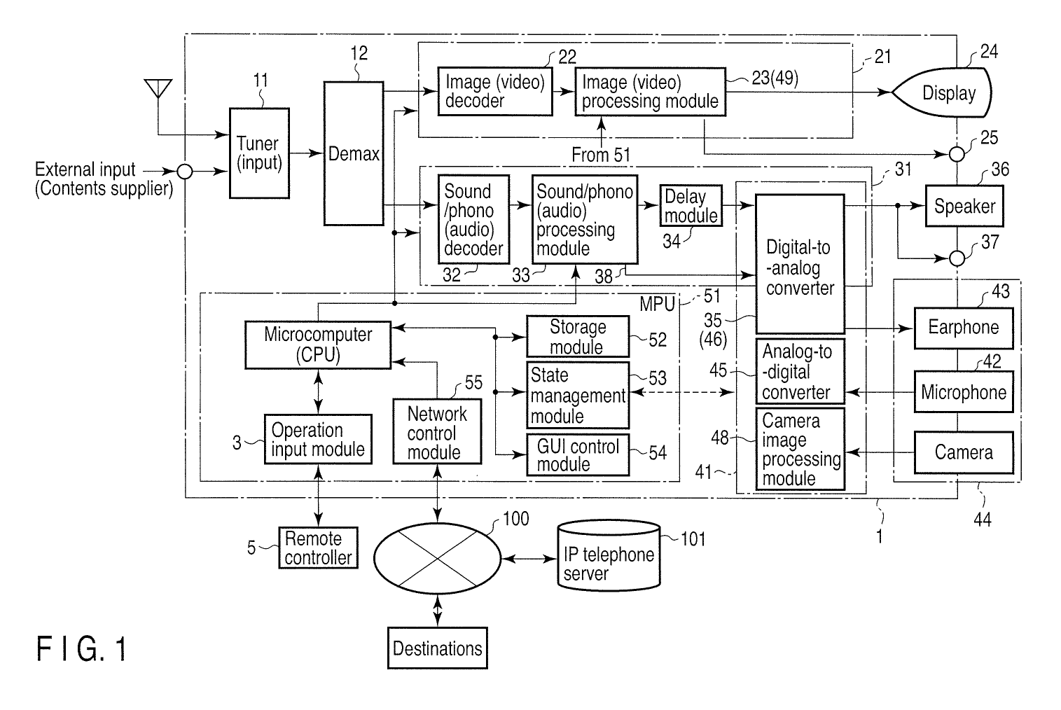

FIG. 1 shows an example of an image display apparatus according to the embodiment, and a communication device incorporated in this image display apparatus. Elements/components described to as “module” below may be obtained by hardware or may be obtained by software using, for example, a microcomputer (processor, CPU), etc.

An image display apparatus 1 shown in FIG. 1 includes a television receiver (hereinafter referred to as a TV apparatus) for receiving a television broadcast and reproducing sound (audio/phono) and images (video).

The TV apparatus (image display apparatus) 1 is capable of receiving and reproducing at least digital broadcast programs, that is, content. In addition, the TV apparatus 1 is capable of receiving content supplied over the Internet (network) 100. The TV apparatus 1 can also use an IP telephone that enables the TV apparatus 1 and a given party (one of destinations) connected to the TV apparatus 1 over the Internet 100 to effect communication based on sound (including audio/phono) and moving images (video) using Internet Protocol (IP).

In the TV apparatus 1, the content received by a tuner 11 for receiving content (programs) is separated into image (video) data and sound (audio) data by a demux (separating module) 12.

The image (video) data separated by the demux 12 is decoded by an image (video) decoder 22 of an image (video) processing block 21, and output as a digital image (video) signal.

The image (video) data decoded by the image decoder 22 is input to an image (video) processing module 23 for processing the data so that the data can be displayed on an image output device. The image (video) data is then converted to predetermined resolution and an output mode, for example, interlace (i)/noninterlace (p) so that a subsequent display 24 can display the data. Further, the image (video) data is supplied to the display 24. An output of the image (video) processing module 23 may be output to an output terminal 25 to which, for example, an external monitor device or a projection device (projector device) can be connected.

The sound data separated by the demux 12 is decoded by a sound (audio) decoder 32 of a sound (audio) processing block 31, and output as a digital sound (audio) signal.

The sound (audio) signal decoded by the sound decoder 32 is input to a digital-to-analog converter 35 via a sound (audio) processing module 33 and a delay module 34. The sound (audio) processing module 33 processes the sound (audio) signal so that a sound output device can reproduce the signal. The delay module 34 provides the output of the sound (audio) processing module 33 with a delay of a predetermined time delays the sound (audio) in order to have time alignment with the image signal output by the image (video) processing module 23. The digital-to-analog converter 35 obtains an analog sound (audio) output.

The analog sound (audio) output from the digital-to-analog converter 35 is input to, for example, a speaker 36. The output from the digital-to-analog converter 35 may further be branched to an output terminal 37 to which, for example, an audiovisual (AV) amplifier can be connected.

The sound (audio/phono) signal to which the delay of the predetermined time is provided by the delay module 34 is also branched to an IP telephone control module 41. The IP telephone control module 41 can be connected to a communication set 44 that includes, for example, a sound (phono) input module (microphone) 42 and a sound reproducing module (an earphone or a low-output speaker for sound reproduction) 43. The IP telephone control module 41 includes an analog-to-digital converter 45 for analog-to-digital conversion of an input from the sound input module 42, and a digital-to-analog converter 46 for digital-to-analog conversion of an output to the sound reproducing module. The digital-to-analog converter 46 for the digital-to-analog conversion of the output to the sound reproducing module is shared by the digital-to-analog converter 35 of the sound (audio) processing block 31.

The IP telephone control module 41 can include a camera 47 for acquiring, for example, an image of the face of a user, and a camera image processing module 48. The IP telephone control module 41 can also include an image processing module 49 for reproducing an image transmitted from a communication party (destinations).

The image processing module 49 can reproduce a still image typified by, for example, Joint Photographic Experts Group (JPEG), or moving images typified by, for example, Moving Picture Experts Group (MPEG) −2, −4 (H.264-AVC). The image processing module 49 for reproducing moving images is shared by the image (video) processing module 23 of the image (video) processing block 21.

In the TV apparatus (image display apparatus) 1, the tuner 11, the demux 12, the image (video) processing block 21, the sound (audio) processing block 31, and the IP telephone control module 41 are controlled by a main control block 51, and perform predetermined operations, respectively.

The main control block (Main Processing Unit, MPU) 51 includes, for example, a Central Processing Unit (CPU) or a microcomputer. The MPU 51 includes, for example, at least a memory module 52, a state management module 53, a GUI control module 54, and a network control module 55. The memory module 52 includes at least a ROM retaining an operation program, and a RAM functioning as a work memory. The state management module 53 manages reception in the IP telephone control module 41 from the outside over the Internet, and transmission from the IP telephone control module 41 to the outside. The GUI control module 54 processes the display of a graphical user interface (GUI) on the display 24, and a user input from the GUI. The network control module 55 controls the connection with the Internet 100, that is, the acquisition of various kinds of data from the Internet and accesses to the Internet 100 from the user.

An operation input module 3 for accepting control inputs from the user is also connected to the MPU 51.

The operation input module 3 includes, for example, at least a receiving module which accepts instructions or control inputs from a channel key (button) for specifying a channel to be chosen by the tuner (input) 11, a power switch used for power on/off, or a remote controller 5. For example, a keyboard (a key operation input unit) which enables the input of characters, signs or numeric characters may otherwise be connected.

The IP telephone control module 41 can packetize the voice of the user acquired by the microphone 42 of the communication set 44 and transmit the packetized voice to the communication destination (party) connected via the network (Internet) in accordance with firmware of the MPU 51, or an IP telephone program that is operated by a prepared program, for example, “Skype” which is an Internet telephone provided by Skype corporation. It should be understood that when the camera 47 is prepared, an image of the user can be packetized and transmitted together with sound.

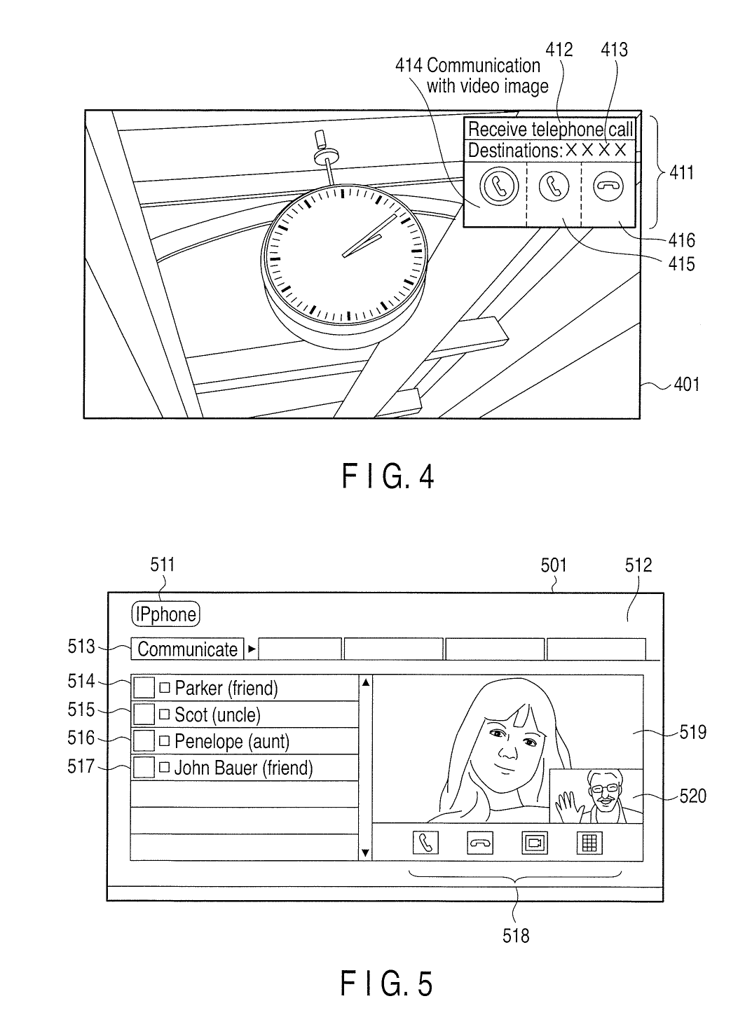

If an IP telephone call is received via the Internet 100 while a program (content) is being viewed by the TV apparatus 1, a “reception display” 411 is displayed under the control of the GUI control module 54 at a given position in an “image display” 401 of the viewed program shown in FIG. 4, or at the upper right in the example shown in FIG. 4.

The “reception display” 411 includes, for example, a “reception indicator” 412 for indicating the presence of reception, a “destinations indicator” 413 for indicating a transmission source, that is, the destination, an “answer indicator <1>” 414 for indicating how to answer, an “answer indicator <2>” 415, and an “answer indicator <3>” 416. The “answer indicator <1>” 414 indicates an image-attached reception answer. The “answer indicator <2>” 415 indicates a reception answer with sound alone. The “answer indicator <3>” 416 indicates no answer to be made. Thus, the viewer chooses any answering method by cursor movement or focusing the remote controller 5 and can thereby choose whether or not to answer.

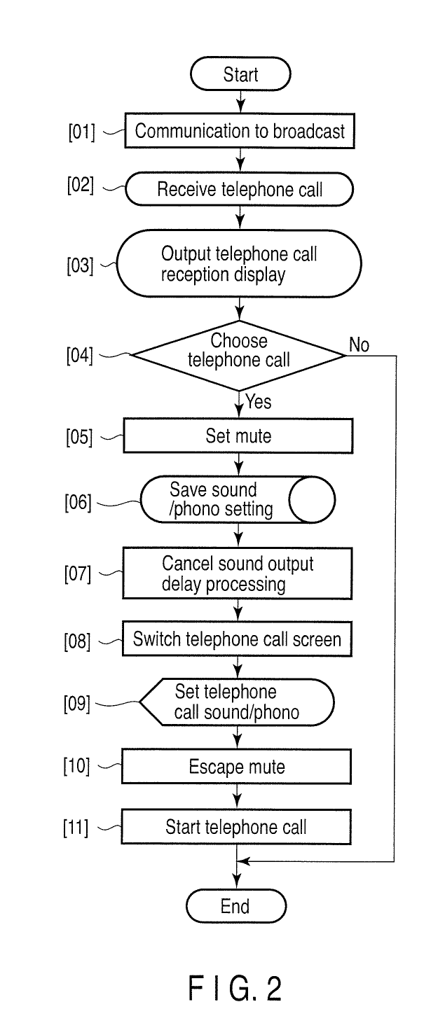

FIG. 2 illustrates an example of how to switch a display screen and how to control a sound output when an IP telephone call is received while a broadcast is being viewed and the user chooses the telephone call.

If a telephone call is received [02] while a broadcast is being viewed [01], the “reception indicator” 412 described with reference to FIG. 4 is displayed in the “image display” 401 [03].

When the user chooses the “answer indicator <1>” described with reference to FIG. 4, that is, the image-attached reception answer [04—YES], the output of the sound (audio) decoder 32 of the sound (audio) processing block 31 is temporarily muted to set the sound volume to zero [05]. At the same time, as data used to restore the sound (audio) output to an original condition during viewing at the end of the IP telephone call, an audio setting condition is temporarily saved in the RAM of the memory module 52 or in the firmware of the MPU (microcomputer) 51 [06].

Furthermore, audio output delay processing is eliminated in order to remove, during the viewing of the program (content), a delay component in an image (video) output (from the sound (audio) output) caused in the image (video) processing module 23 for processing the image (video) data decoded by the image decoder 22 so the image output device can display the image (video) data [07]. In actual control, the output of the sound (audio) processing module 33 may be input not to the delay module 34 but directly to the digital-to-analog converter 35 by a switch (signal) line under the control of, for example, the MPU 51. That is, the time difference between the sound (audio) output and the image (video) output is brought to substantially zero or a predetermined allowable time of, for example, 200 ms or less. It should be understood that a path which does not pass via the delay module 34 can be used by preparing, for example, a switch. It goes without saying that an IP telephone call may only comprise sound (audio).

As a result of the elimination of the delay processing by the delay module 34 [07], a great gap between the images and sound attached to an IP telephone call is prevented by “the adjustment (delay) of the output of sound to the display of the image” which is widely used in the TV apparatus 1 that mainly processes digital broadcast reception.

That is, in a telephone call including sound alone (a general telephone call), it is generally desired that the voice of the destination be output in a period of about 200 ms to achieve answer performance that enables a comfortable telephone call. This allows an improvement in the replay performance in the IP telephone call that is said to be decreased when a delay in the TV apparatus that mainly processes digital broadcast reception is effective. The delay in the TV apparatus that mainly processes digital broadcast reception is, for example, about two seconds. The condition of an IP telephone call significantly deteriorates (answer performance decreases) when the delay is effective. Thus, the elimination of the delay processing by the delay module 34 is significantly advantageous.

Following the elimination of the delay processing by the delay module 34, the display screen is switched to a “telephone call screen” 501 shown in FIG. 5 [08]. The “telephone call screen” 501 includes a “mode indicator” 511 for indicating that, for example, an IP telephone call mode” is active, a “receiving indicator” 512 that indicates a receiving state (waiting for a telephone call), a “destination indicator for communicate” 513 that indicates a destination to communicate, and a “telephone directory (destinations list) indicator” 514 to 517 (e.g., one of destinations 514 for friend: Parker; one of destinations 515 for uncle: Scot; one of destinations 516 for aunt: Penelope; and one of destinations 517 for friend: John Bauer), an “operation indicator” 518 that indicates, for example, the operation of the camera, and “image indicators” 519 and 520 that indicate images of the face of the destination and the face of the user.

Furthermore, simultaneously with the display of the “telephone call screen” 501 or in accordance with predetermined timing, telephone call sound is set; for example, the level of voice transmitted by the user (the sensitivity of the microphone 42), and the reproduction level of the voice of destinations (the volume level of output to the earphone 43) are set [09].

The mute is then canceled [10], and preparation for a telephone call is completed, such that a telephone call (transmission and reception) can be made [11].

Thus, regarding the sound (audio) output of an IP telephone call received while a program is being viewed by the TV apparatus 1, the delay (an adjustment for removing the time difference between the sound (audio) output and the image (video) output) of sound generally used by the delay module 34 is cancelled during the viewing of the program by the TV apparatus 1, and the time difference between the images and sound during an IP telephone call is substantially eliminated. Consequently, comfortable answer performance can be obtained.

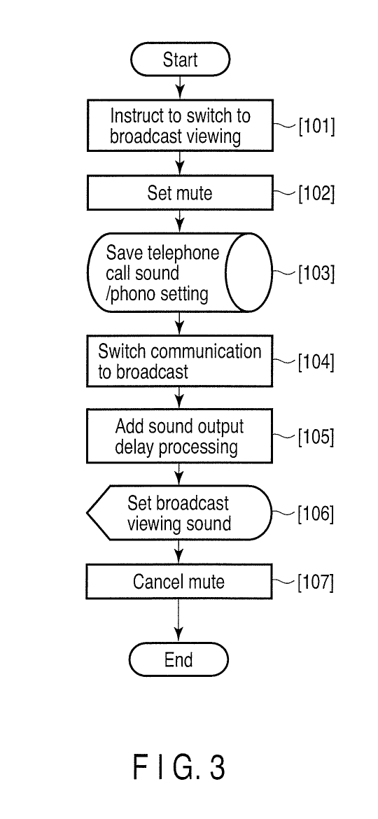

FIG. 3 shows an example of control when the user chooses a broadcast to view after the end of the IP telephone call shown by way of example in FIG. 2.

Described are the case where the IP telephone call has ended, the case where, for example, an IP telephone call between the user and another destination is started, and the case where the user continues to view the program by the TV apparatus 1 after the end of the IP telephone call in FIG. 3 although the user may not continue to view the program by the TV apparatus 1, for example, may go outside or search for a document depending on the contents of the ended IP telephone call.

In response to an instruction to continue the viewing of the program (broadcast), that is, to switch to broadcast viewing after the end of the IP telephone call [101], the output of the sound (audio) decoder 32 of the sound (audio) processing block 31 is temporarily muted to set the sound volume to zero [102]. At the same time, the telephone call sound setting, for example, the level of sound transmitted by the user (the sensitivity of the microphone 42) and the reproduction level of the voice of destination (the volume level of output to the earphone 43) are saved to prepare for a next IP telephone call [103].

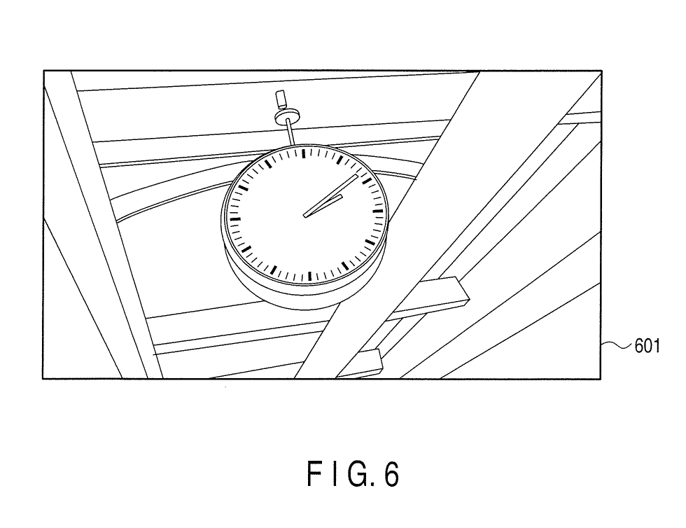

Furthermore, in accordance with predetermined timing, the output of the image (video) processing module 23 is changed to the program (content) which has been previously viewed, and an “image” 601 of the program (content) viewed before the start of the IP telephone call is displayed on the display 24, as shown in FIG. 6 [104].

The output of the sound (audio) processing module 33 is then switched to a TV mode to pass via the delay module 34. That is, the delay processing by the delay module 34 is added to the output of the sound (audio) processing module 33 [105]. As a result, “the adjustment (delay) of the output of sound to the display of the image” which is generally applied to the TV apparatus 1 that mainly processes digital broadcast reception is restored. This prevents the gap between the images and sound of the program (content) to is viewed. At the same time, as data used to restore the sound (audio) output to an original condition during viewing described with reference to FIG. 2, an audio setting condition is read from the RAM of the memory module 52 or the firmware of the MPU (microcomputer) 51, and sound setting suitable for the viewing of the program (content) by the TV apparatus 1 is provided [106]. New sound setting may be provided in accordance with the details of the program (content). For example, the program (content) viewed before the start of the IP telephone call is, for example, a sports relay, and a suitable sound field, for example, a stadium (dome) mode/sports mode is set. When the program (content) viewed after the end of the IP telephone call is a news program, the sound setting may be set to, for example, a studio relay/new mode.

The mute is then canceled [107], and the program (content) received by the TV apparatus 1 can be viewed.

As described above, according to this suggestion, when an IP telephone call is received during the viewing of a program on the digital TV apparatus capable of the IP telephone call, the delay of sound by the delay module which is set for the sound (audio) output during the viewing of the program on the digital TV apparatus is cancelled, and the time difference between images and sound during the IP telephone call is substantially eliminated, such that comfortable answer performance can be also obtained for the IP telephone call that uses a TV apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
a communication processing module configured to receive sound and an image over a network;
an image processing module configured to output an image signal;
a sound processing module configured to output a sound signal;
a converting module configured to convert the sound signal output by the sound processing module to an analog signal; and
an adjusting module configured to adjust a time difference to be provided to the sound signal input to the converting module by the sound processing module in accordance with the image signal when the image signal output by the image processing module is an image signal input via the communication processing module.

2. The image display apparatus of claim 1, wherein the image input over the network is compliant with Internet Protocol (IP).

3. The image display apparatus of claim 2, wherein the adjusting module sets the time difference to zero when the image signal is input over the network.

4. The image display apparatus of claim 2, wherein the adjusting module sets the time difference to zero when the sound signal is input over the network.

5. A sound output control method comprising:
receiving sound and an image over a network;
decoding and outputting an image signal; and
adjusting a time difference between a sound signal which is decoded and output and the image signal.

6. The sound output control method of claim 5, wherein the adjustment includes an adjustment that sets the time difference to zero when the image signal is input over the network.

7. The sound output control method of claim 5, wherein the adjustment includes an adjustment that sets the time difference to zero when the sound signal is input over the network.
